(19) United States
(12) Patent Application Publication
(10) Pub. No.: US 2017/0345437 A1
(43) Pub. Date: Nov. 30, 2017

(54) VOICE RECEIVING METHOD AND DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventor: YU ZHANG, Shenzhen (CN)

(21) Appl. No.: 15/607,419

(22) Filed: May 26, 2017

(30) Foreign Application Priority Data
May 27, 2016 (CN) 201610368408.3

(51) Int. Cl. G10L 21/0216; G10L 21/028; G10L 21/0224; G10L 21/10

(52) U.S. Cl. CPC G10L 21/0216; G10L 21/10; G10L 21/028; G10L 21/0224; G10L 2021/02165; G10L 2021/105

(57) ABSTRACT

A voice receiving device configured for accurate listening includes a microphone array, a camera, a capturing module, a determining module, a time module, a calculating module, and a de-noising module. The microphone array captures a first voice signal and a second voice signal and the camera captures mouth pictures of a user. The determining module determines whether the first voice signal is synchronized with the mouth pictures, and if so compares the first voice signal to a model preset voice signal of a user to determine a target voice signal. The time module obtains time delay difference between one voice reaching different microphones. The calculating module calculates a position of sound source of the target voice signal. According to the position of the sound source, the de-noising module de-noises by reference to the second voice signal. The disclosure further provides a voice receiving method.

### CROSS-REFERENCE TO RELATED APPLICATIONS

This application claims priority to Chinese Patent Application No. 201610368408.3, filed on May 27, 2016, the contents of which are incorporated by reference herein.

### FIELD

The subject matter herein generally relates to electronic control by voice and electronic devices of receiving voice.

### BACKGROUND

Communication devices, for example mobile phones, have two microphones. A first microphone receives main voice. A second microphone receives non-main voice. The first microphone and the second microphone are connected to a noise reducer. The noise reducer eliminates noise in the main voice. When the first microphone is away from mouth of a person and the second microphone is adjacent to the mouth, noise cannot be completely eliminated.

### BRIEF DESCRIPTION OF THE DRAWINGS

Implementations of the present technology will now be described, by way of example only, with reference to the attached figures.

FIG. 1 is a schematic diagram of a voice receiving device.

FIG. 2 is a block diagram of voice receiving system in FIG. 1, according to an exemplary embodiment.

FIG. 3 is a flowchart of a voice receiving method, according to an exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the exemplary embodiments described herein.

A definition that applies throughout this disclosure will now be presented.

The term “comprising” means “including, but not necessarily limited to”; it specifically indicates open-ended inclusion or membership in a so-described combination, group, series, and the like.

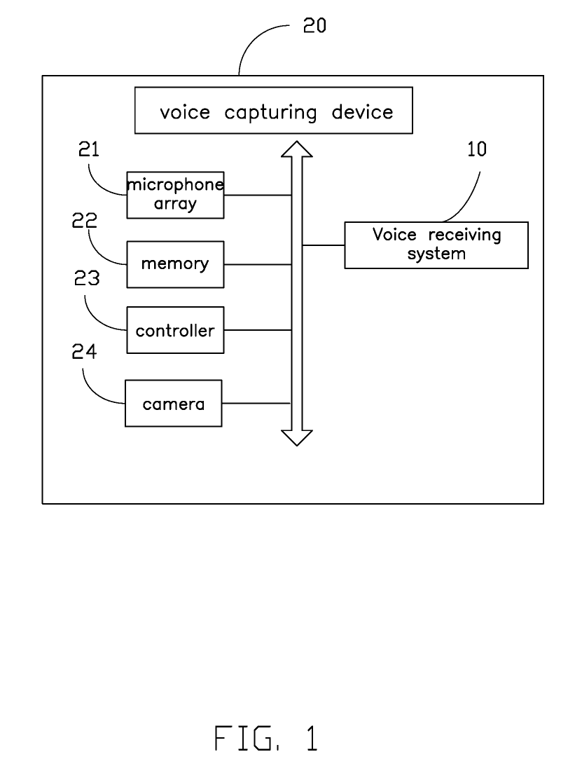

FIG. 1 illustrates a voice receiving system 10 employed in a voice receiving device 20. The voice capturing device 20 can be a mobile phone, a tablet computer, a recording pen, or a telephone. In another embodiment, the voice receiving system 10 may be employed for a telephone conference having a number of the voice capturing devices 20.

The voice receiving system 10 includes a microphone array 21, a memory 22, a controller 23, and a camera 24. The microphone array 21 is configured to receive voice. The microphone array 21 includes at least two microphones installed at different positions of the voice capturing device 20. The memory 22 stores programs of the voice receiving system 10 and other data. The memory 22 prestores a voice model of a target user. According to the voice of the target user, the voice receiving system 10 determines whether received voice includes the voice of the target user. In other embodiment, the memory 22 further prestores mouth pictures of the target user, for example, a picture of the target user talking. The controller 23 is configured to control the voice capturing device 20 to work. The camera 24 is configured to capture a mouth picture of a user. Furthermore, the camera 24 can capture a mouth video of the user. The camera 24 and the microphone array 21 are within a preset distance, for example, two centimeters from each other.

The microphone array 21 captures a first voice and converts the first voice to a first voice signal. The first voice includes a target voice and a background noise. When the voice receiving system 10 receives the first voice signal, the voice receiving system 10 determines whether the mouth picture captured by the camera is changed. When the mouth picture is changed, the voice receiving system 10 compares the first voice signal and the prestored voice signal to determine a target voice signal. The voice receiving system 10 further obtains time of delay between the microphones of the microphone array 21 and calculates a position of the target voice corresponding to the target voice signal. When the position of the target voice is determined, the microphone array 21 captures a second voice and converts the second voice to a second voice signal. According to position of the target voice, the voice receiving system 10 de-noises the second voice signal.

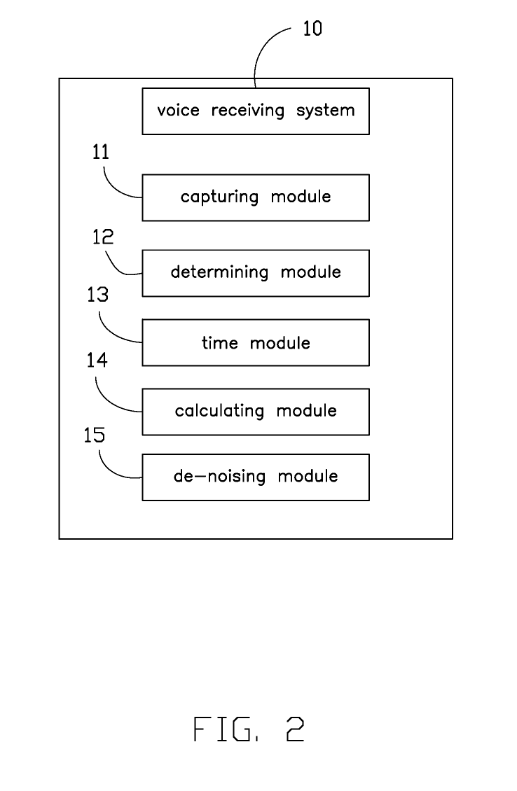

FIG. 2 illustrates the voice receiving system 10 as including a capturing module 11, a determining module 12, a time module 13, a calculating module 14, and a de-noising module 15. The capturing module 11, the determining module 12, the time module 13, the calculating module 14, and the de-noising module 15 include computerized codes in the form of one or more programs executed in the controller 23.

In response to an operation, the capturing module 11 controls the microphone array 21 to capture the first voice and convert the first voice to the first voice signal. The first voice includes the target voice and the background noise. The capturing module 11 further controls the camera 24 to capture the mouth picture. The operation may be making a call or recording voice. The camera 24 is installed on the voice capturing device 20 and configured to capture a picture within a preset area in front of the voice capturing device 20. When a user talks in the preset area, the camera 24 can capture a number of mouth pictures of the user.

The determining module 12 determines whether the first voice synchronizes with the mouth picture. In the embodiment, when mouth shape in the mouth pictures is changed, talking by user is indicated. Thus, when the capturing module 11 captures the first voice and the mouth shape in the mouth pictures is changed, the determining module 12 determines whether the first voice is synchronized with the mouth picture.

In the mouth pictures, if the mouth of one of the mouth pictures is closed and the mouth of another of the mouth pictures is opened, the determining module 12 determines that the mouth shape is changed.

The determining module 12 further compares the first voice signal to a preset voice signal to determine a target voice signal.

The preset voice signal is a user voice signal prestored in the memory 22. The preset voice signal includes voice frequency and voice amplitude. The determining module 12 compares frequency of the first voice signal to frequency of the preset voice signal. When the frequency of the first voice signal is approximately the same as the frequency of the preset voice signal, the determining module 12 determines that the first voice signal includes the target voice signal.

In another embodiment, the determining module 12 compares voice amplitude of the first voice signal to the voice amplitude of the preset voice signal. When the voice amplitude of the first voice signal is approximately the same as the voice amplitude of the preset voice signal, the determining module 12 determines that the first voice signal includes the target voice signal.

The time module 13 obtains time of delay between the microphones of the microphone array 21 when the microphones capture the target voice signal. In the embodiment, the microphone array 21 includes at least two microphones installed at different positions of the voice capturing device 20. Because the microphones are installed at different positions of the voice capturing device 20, time of one voice reaching the microphones is not the same. According to the difference in times, the time module 13 obtains time delay between the microphones of the microphones array 21.

According to the time delay, the calculating module 14 calculates the position of sound source of the target voice signal. In the embodiment, the position of the sound source of the target voice signal includes distance and orientation.

The capturing module 11 controls the microphone array 21 to capture a second voice and converts the second voice to a second voice signal. According to position of the target voice signal, the de-noising module 15 de-noises the second voice signal.

In the embodiment, the de-noising module 15 transmits voice signal belonging to the target voice signal in the second voice signal to a voice delivery channel and transmits voice signal in the second voice signal not belonging to the target voice signal to a noise delivery channel. According to the voice signal transmitted to the noise delivery channel, de-noises the voice signal transmitted to the voice delivery channel.

To de-noise noise signal, the de-noising module 15 eliminates a part of the second voice signal which has frequency which does not substantially repeat the frequency of the preset voice signal. In another embodiment, the de-noising module 15 also eliminates a part of the second voice signal which does not have a voice amplitude similar to the voice amplitude of the preset voice signal.

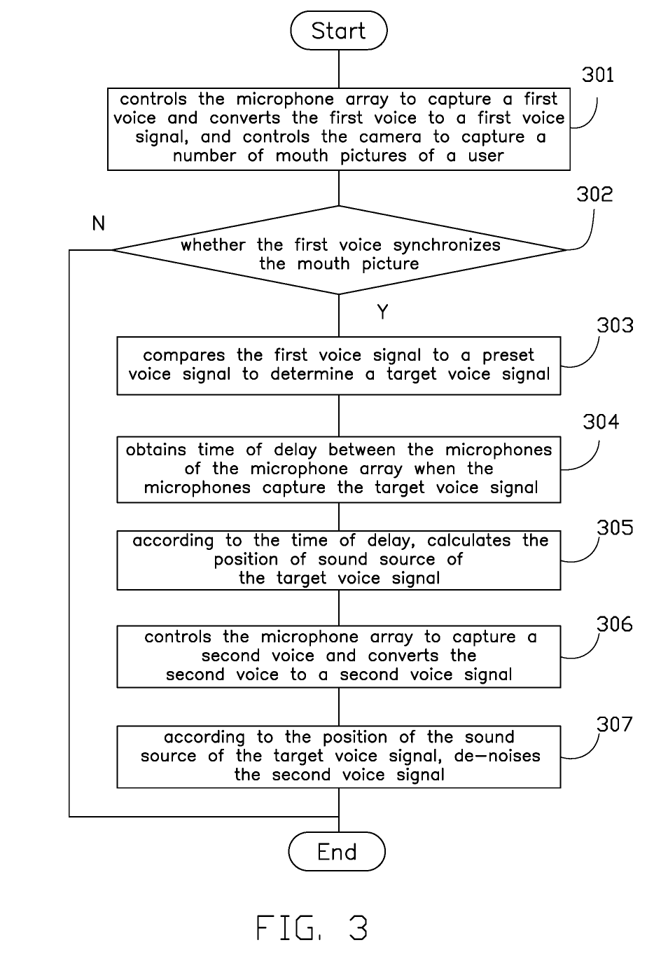

FIG. 3 illustrates a voice receiving method according to an embodiment. The order of blocks in FIG. 3 is illustrative only and the order of the blocks can change. Additional blocks can be added or fewer blocks may be utilized without departing from this disclosure. The exemplary method begins at block 301.

At block 301, in response to an operation, the capturing module 11 controls the microphone array 21 to capture a first voice and converts the first voice to a first voice signal, and controls the camera 24 to capture a number of mouth pictures of a user. The first voice includes a target voice and a background noise.

The operation may be making a call or recording voice. The camera 24 is installed on the voice capturing device 20 and configured to capture a picture within a preset area in front of the voice capturing device 20. When a user talks in the preset area, the camera 24 captures mouth pictures of the user.

At block 302, the determining module 12 determines whether the first voice synchronizes with the mouth picture. When the first voice synchronizes with the mouth picture, the procedure goes block 303. Otherwise, the procedure ends.

When mouth shape in the mouth pictures is changed, talking by user is indicated. Thus, when the capturing module 11 captures the first voice and the mouth shape in the mouth pictures is changed, the determining module 12 determines whether the first voice is synchronized with the mouth picture. In the mouth pictures, if the mouth of one of the mouth pictures is closed and the mouth of another of the mouth pictures is opened, the determining module 12 determines that the mouth shape is changed.

At block 303, the determining module 12 compares the first voice signal to a preset voice signal to determine a target voice signal.

The preset voice signal is a user voice signal prestored in the memory 22. The preset voice signal includes voice frequency and voice amplitude. The determining module 12 compares frequency of the first voice signal to frequency of the preset voice signal. When the frequency of the first voice signal is approximately the same as the frequency of the preset voice signal, the determining module 12 determines that the first voice signal includes the target voice signal. The target voice signal is from the user.

In another embodiment, the determining module 12 compares voice amplitude of the first voice signal to the voice amplitude of the preset voice signal. When the voice amplitude of the first voice signal is approximately the same as the voice amplitude of the preset voice signal, the determining module 12 determines that the first voice signal includes the target voice signal.

At block 304, the time module 13 obtains time of delay between the microphone of the microphone array 21 when the microphones capture the target voice signal.

In the embodiment, the microphone array 21 includes at least two microphones installed at different positions of the voice capturing device 20. Because the microphones are installed at different positions of the voice capturing device 20, time of one voice reaching the microphones is not the same. According to the difference in times, the time module 13 obtains time delay between the microphones of the microphone array 21.

At block 305, according to the time of delay, the calculating module 14 calculates the position of sound source of the target voice signal. In the embodiment, the position of the sound source of the target voice signal includes distance and orientation.

At block 306, the capturing module 11 controls the microphone array 21 to capture a second voice and converts the second voice to a second voice signal.

At block 307, according to the position of the sound source of the target voice signal, the de-noising module 15 de-noises the second voice signal.

In the embodiment, the de-noising module 15 transmits voice signal belonging to the target voice signal in the second voice signal to a voice delivery channel and transmits voice signal in the second voice signal not belonging to the target voice signal to a noise delivery channel, and according to the voice signal transmitted to the noise delivery channel, de-noise in the voice signal transmitted to the voice delivery channel.

The de-noising module 15 eliminates a part of the second voice signal which has frequency which does not substantially repeat the frequency of the preset voice signal. In another embodiment, the de-noising module 15 eliminates a part of the second voice signal which does not have a voice amplitude similar to the voice amplitude of the preset voice signal.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A voice receiving method employed in a voice capturing device, the voice capturing device comprising a microphone array, the voice receiving method comprising:
in response to an operation, controlling the microphone array to capture a first voice and converting the first voice into a first voice signal, and capturing a plurality of mouth pictures of a user, wherein the first voice comprises a target voice and a background noise;
determining whether the first voice synchronizes with the mouth pictures;
when the first voice synchronizes with the mouth picture, comparing the first voice signal to a preset voice signal to determine a target voice signal;
obtaining time of delay between the microphones of the microphone array when the microphones capture the target voice signal;
according to the time of delay, calculating a position of sound source of the target voice signal;
controlling the microphone array to capture a second voice and converting the second voice to a second voice signal; and
according to the position of the sound source, de-noising the second voice signal.

2. The voice receiving method as claimed in claim 1, wherein the microphone array comprises at least two microphones installed at different positions of the voice capturing device.

3. The voice receiving method as claimed in claim 2, wherein the position of the sound source of the target voice signal comprises distance and orientation.

4. The voice receiving method as claimed in claim 1, wherein “according to the position of the sound source, de-noising the second voice signal” comprising:
transmitting voice signal belonging to the target voice signal in the second voice signal to a voice delivery channel and transmitting voice signal in the second voice signal not belonging to the target voice signal to a noise delivery channel; and
according to the voice signal transmitted to the noise delivery channel, de-noising the voice signal transmitted to the voice delivery channel.

5. The voice receiving method as claimed in claim 4, wherein comprising:
eliminating a part of the second voice signal which has frequency which does not substantially repeat the frequency of the preset voice signal.

6. The voice receiving method as claimed in claim 4, wherein comprising:
eliminating a part of the second voice signal which does not have a voice amplitude similar to the voice amplitude of the preset voice signal.

7. The voice receiving method as claimed in claim 1, wherein the preset voice signal is a prestored user voice signal.

8. The voice receiving method as claimed in claim 1, wherein “comparing the first voice signal to a preset voice signal to determine a target voice signal” comprising:
comparing frequency of the first voice signal to frequency of the preset voice signal; and
when the frequency of the first voice signal is approximately the same as the frequency of the preset voice signal, determining the first voice signal comprising the target voice signal.

9. The voice receiving method as claimed in claim 1, wherein “comparing the first voice signal to a preset voice signal to determine a target voice signal” comprising:
comparing voice amplitude of the first voice signal to the voice amplitude of the preset voice signal; and
when the voice amplitude of the first voice signal is approximately the same as the voice amplitude of the preset voice signal, determining the first voice signal comprising the target voice signal.

10. The voice receiving method as claimed in claim 1, wherein the operation is making a call.

11. A voice receiving device comprising:
a microphone array;
a camera;
a capturing module, configured to, in response to an operation, control the microphone array to capture a first voice and convert the first voice to a first voice signal, and control the camera to capture a plurality of mouth pictures of a user, wherein the first voice comprises a target voice and a background noise;
a determining module configured to determine whether the first voice synchronizes the mouth pictures, and when the first voice synchronizes the mouth pictures, compare the first voice signal to a preset voice signal to determine a target voice signal;
a time module configured to obtain time of delay between the microphones of the microphone array when the microphones capture the target voice signal;
a calculating module configured to, according to the time of delay, calculate a position of sound source of the target voice signal;
the capturing module further configured to control the microphone array to capture a second voice and convert the second voice to a second voice signal; and
a de-noising module configured to, according to the position of the sound source, de-noise the second voice signal.

12. The voice receiving device as claimed in claim 11, wherein the microphone array comprises at least two microphones installed at different positions of the voice capturing device.

13. The voice receiving device as claimed in claim 12, wherein the position of the sound source of the target voice signal comprises distance and orientation.

14. The voice receiving device as claimed in claim 11, wherein the de-noising module transmits voice signal in the second voice signal belonging to the target voice signal to a voice delivery channel and transmits voice signal in the second voice signal not belonging to the target voice signal to a noise delivery channel; and according to the voice signal transmitted to the noise delivery channel, de-noising the voice signal transmitted to the voice delivery channel.

15. The voice receiving device as claimed in claim 14, wherein the de-noising module eliminates a part of the second voice signal having frequency without the frequency of the preset voice signal from the second voice signal.

16. The voice receiving device as claimed in claim 14, wherein the de-noising module eliminates a part of the second voice signal having voice amplitude without the voice amplitude of the preset voice signal from the second voice signal.

17. The voice receiving device as claimed in claim 11, wherein the preset voice signal is a prestored user voice signal.

18. The voice receiving device as claimed in claim 11, wherein the determining module compares frequency of the first voice signal to frequency of the preset voice signal; and when the frequency of the first voice signal is within the frequency of the preset voice signal, the determining module determines the first voice signal comprising the target voice signal.

19. The voice receiving device as claimed in claim 11, wherein the determining module compares voice amplitude of the first voice signal to voice amplitude of the preset voice signal; and when the voice amplitude of the first voice signal is within the voice amplitude of the preset voice signal, the determining module determines the first voice signal comprising the target voice signal.

20. The voice receiving device as claimed in claim 11, wherein the operation is making a call.
